(19) United States
(12) Patent Application Publication
(10) Pub. No.: US 2024/0120799 A1
(43) Pub. Date: Apr. 11, 2024

(54) MULTI-PART INVERTER FOR ELECTRICAL MACHINE WITH MULTIPLE WINDING SYSTEMS

(71) Applicant: Vitesco Technologies GmbH, Regensburg (DE)

(72) Inventor: Ayman Ayad, München (DE)

(21) Appl. No.: 18/373,413

(22) Filed: Sep. 27, 2023

(30) Foreign Application Priority Data
Oct. 6, 2022 (DE) 10 2022 210 547.8

(51) Int. Cl. H02K 5/22; H02K 11/33; H02P 27/08

(52) U.S. Cl. CPC H02K 5/225; H02K 11/33; H02P 27/08; H02K 7/006

(57) ABSTRACT

An electric vehicle drive circuit has a first inverter with a first DC port and a second inverter with a second DC port. The first DC port and the second DC port are connected in a series connection. The series connection of the first and the second DC port is connected to a battery interface. The first and the second inverters each have a multiphase AC port. The multiphase AC ports of the first and the second inverters form a multiphase machine interface.

### CROSS REFERENCE TO RELATED APPLICATIONS

This application claims priority to German Patent Application No. 10 2022 210 547.8, filed Oct. 6, 2022, the contents of such application being incorporated by reference herein.

### BACKGROUND OF THE INVENTION

Vehicles with an electric drive use high operational voltages for providing a driving power of 100 kW or more. The input voltage for an inverter in such a drive can reach up to 800 V or more. The semiconductor switches in such an inverter are rated according such high voltages, which, in turn, leads to high costs for the semiconductor switches. Further, switches rated according such high operating voltages can have electronic properties which are inferior to switches with lower voltage ratings, in particular in view of the switching behavior of the switches.

### SUMMARY OF THE INVENTION

Thus, an aspect of the invention aims to provide possibility to allow high switching voltages for providing a high drive power ratings with reduced disadvantages as regards the semiconductor switches.

A circuit is proposed, in which multiple inverters are combined to a combined inverter device, wherein the DC side or DC ports of the multiple inverters is connected in series. By the series connection of the DC ports of multiple inverters, each of the multiple inverter operates with a fraction of the overall DC voltage (eg. appearing at the battery interface of the combined inverter device). Thus, each of the multiple inverters can be provided with semiconductor switches rated according only a fraction of the overall DC voltage. It is proposed that the AC ports of the multiple (“stacked”) inverters are adapted for driving a single electrical machine with multiple winding systems. In particular, each AC port of each of the multiple inverters is adapted to be connected to one of the multiple winding systems. The multiple inverters are preferably controlled by a joint control (for all of the stacked inverters). Further, such a circuit can be used for providing a charging function.

Electric vehicle drive circuit is proposed having a first inverter and a second inverter. The first inverter has a first DC port. The second inverter has a second DC port. The DC port corresponds to a DC supply port (in a driving state) and can correspond to a DC output when operating the inverters in opposite directed, eg. for providing a battery charging voltage (DC) at the DC ports. In case the inverters comprise switching elements connected as half bridges, the DC port is connected to the ends of the half bridges. The connection points with in the half bridges can be connected to an AC port of the inverters. The inverters can be provided as unidirectional inverters (for converting DC voltage into an AC voltage for driving an electrical machine) or as bidirectional inverters, which allow an additional function, ie. controlled rectifying.

The first DC port and the second DC port are connected in a series connection. This reduces the DC voltage for each port to a fraction of the overall voltage (provided at the battery interface). Each DC port provides a positive and a negative connector. In the series connection, the negative connector of the first inverter is connected to the positive connector of the second inverter. The positive connector of the first inverter is connected to a positive connector of the battery port. The negative connector of the second inverter is connected to a negative connector of the battery port. The battery port can be considered as DC port of the combined inverter device formed by the multiple inverters. The series connection of the first and the second DC port is connected to the battery interface, ie. to the DC port of the combined inverter device. Each of the inverters has a multiphase AC port. Preferably, each of the inverters has a multiphase AC port with multiple (AC) phase connectors. All inverters, which are combined on the DC side as given herein have the same number of phases. The number of phases of the combined inverter device (or the drive circuit comprising the combined inverter device) is equal to the sum of all phases or phase connectors of the single inverters. The multiphase AC ports of the first and the second inverters form a multiphase machine interface. The phase number of this (AC) interface (of the combined inverter device or the drive circuit) is the sum of all phases of all inverter AC ports. The electric vehicle drive circuit comprises such a combined inverter device or corresponds to the combined inverter device.

In an embodiment, the electric vehicle drive circuit (or the combined inverter device) comprises a control circuit. The control circuit is adapted to switch the switching elements within the inverters. In particular, the control circuit is adapted to control the half bridges of the inverters. The control circuit is adapted to provide a pulse width modulation (PWM) signal to the switches of the inverters. The control circuit is connected to control inputs of both, the first and the second inverters. In particular, the control circuit is connected to control inputs of at least two or all inverters (or a subgroup n>2 thereof) within the drive circuit. The control circuit is adapted to control the first and the second inverters (or all inverters connected therewith) in order to jointly provide a rotary current system (AC) at the multiphase machine interface. The first and the second inverter each can be provided as 3 phase inverter, each having a 3 phase AC port. In this example, the multiphase machine interface is provided as a 6 phase AC port. In case of an additional inverter with 3 phases, the multiphase machine interface is provided as a 9 phase AC port (sum of all 3 phases of all three inverters). The inverters can be adapted to drive multiple the winding systems that operate the same rotor of the electrical machine (ie. winding systems arranged on the same stator). In an example, each inverter can be connected to an (individual) winding system (assigned thereto). The phases of each of the winding systems can be connected in delta configuration or can be in star point configuration. In other examples, the inverters can be adapted to drive one or more open end winding system. In these examples, each winding system is provided with two ends. One of these ends can be connected to a first inverter of the inverters and the opposite end can be connected to a second inverter of the inverters. If more than one winding system is provided, each phase the winding systems as first and second opposing ends, wherein the first ends can be connected to a first inverter or a first group of inverters and the second ends can be connected to a second inverter (not part of the first group) or a second group of inverters (distinct from the first group).

The control circuit is adapted to limit the voltages occurring at the DC ports to a voltage limit not greater than a threshold. The threshold can be the sum of a given voltage tolerance gap and the half of the voltage occurring at the battery interface. In general, if k inverters are combined as given herein, the threshold is 1/k, to which a tolerance gap is added. The control circuit balances the voltages occurring at the DC ports such that the voltages at each port do not differ from each other more than a given limit. The control circuit controls the inverters with individual PWM control signals. The PMW control signals are linked with a certain DC load appearing at the DC port of the inverters. By balancing the appearing DC loads at the DC ports, the voltage appearing at the DC ports is balanced.

Each of the inverters (forming the combined inverter) has a rating voltage lower than the operating voltage or voltage rating of the battery interface. The rating voltage can be defined by the maximum rating of the drain-source or emitter-collector voltage or as the breakdown voltage of the transistors being the switching elements within the inverters.

Preferably, each DC port is provided with an individual link capacitor (a capacitor connected in parallel to the respective DC port). Also, the voltage appearing at the link capacitors is balanced in this way such that they have not to be rated according to the maximum DC voltage of the drive circuit/combined inverter device but according to a fraction thereof. Preferably, a first capacitor is connected in parallel to the first DC port and a second capacitor is connected in parallel to the second DC port. In particular, for each DC port of each inverter, there is an individual capacitor connected in parallel thereto. Sind the DC ports are connected in series, also the capacitors at the DC ports form a series connection. The ends of the series connection is connected with the battery interface (in parallel). The capacitors form a capacitive voltage divider. Also, the DC ports of the inverters form a voltage divider.

Electric vehicle drive circuit can be connected to an electrical machine via the machine interface or can comprise an electrical machine attached to the machine interface. In particular, the winding systems or windings or phase connectors of the electrical machine are connected to the multiphase machine interface. The electrical machine has multiple winding systems and in particular a first and a second winding system. The winding systems are operating the same rotor of the electrical machine. In other words, the winding systems are adapted to jointly create a torque exerted on the rotor. Preferably, both inverters are adapted to jointly provide a single, rotary current system at the multiphase machine interface. The rotary current system created by the inverters is preferably the only current system created by the inverters, The rotary current system is the result of the combined currents given by the inverters. Preferably, the rotary current system has only symmetrical components (as far as the circuit and/or the electrical machine is fault-free). The winding systems can be in star or in delta configuration (as mentioned above). Further, the winding systems can be open end winding systems, wherein opposite ends are connected to distinct inverters. The inverters and preferably the controls thereof are adapted to providing a rotary field within the electrical machine for winding systems in star configuration or delta configuration or for winding systems with open ends.

The drive circuit is adapted to transfer electrical power from the battery interface (DC voltage/power) to the multiphase AC ports (AC voltage/power), thereby carrying out an inversion (converting DC voltage/power to AC voltage/power). The drive circuit can be unidirectional and provide a power path from the battery interface to the multiphase AC ports (ie. to the electrical machine).

Embodiments of the circuit additionally allow the opposite power transfer direction. Thus, the inverters and the circuit can be provided bidirectional. This allows generated electrical power to be provided at the multiphase AC ports or the electrical machine to be transferred to the battery interface. This transfer is linked with a rectification. In particular, this allows to transfer electrical energy generated by the electrical machine to be transferred to the battery port and allows to transfer electrical energy provided by an external charging station (DC or AC charging station) at the multiphase AC ports to be transferred to the battery port. This transfer (also denoted as recuperation or AC-charging or DC-charging) is linked with a rectification process, which is preferably a controlled rectification process.

The drive circuit can comprise a charging interface, in particular a DC charging interface or an AC charging interface (three-phase or single-phase). This charging interface or a connector thereof is connected to a star point of a first of the winding systems. Preferably, the charging interface or another connector thereof is connected to the battery interface or a connector thereof. In particular, a first connector (e.g. the positive one) of the charging interface is connected to the star point of the first winding system, the first winding system being connected to the multiphase AC port of the first inverter, e.g. the inverter connected to a first (e.g. positive) connector of the battery interface. A second connector (e.g. the negative one) of the charging interface is connected to the other (e.g. negative) connector of the battery interface.

The charging interface provided as DC charging interface comprises two voltage connectors (V+, V−). A capacitive series connection can be provided at the charging interface being connected on parallel to the voltage connectors of the charging interface. The capacitive series connection at the charging interface comprises two capacitors connected in series via a junction point. In other words, the capacitive series connection has a junction point. This junction point is connected to a star point of a second of the winding systems. In case of more than two inverters within the circuit, the number of capacitors in the capacitive series connection equals the number of inverters, each of the star points being connected to an individual star point (except for a first star point being connected to a connector of the charging interface. The charging interface can be connected to at least one star point of the windings or can be connected to an open end (or a first side of the open ends) of the windings.

The connection between the first (positive) connector of the charging interface and the first star point/first winding system/open end can be a switched connection. This connection can comprise a switch, in particular a breaker switch. The connection between the second (negative) connector of the charging interface and respective connector of the battery interface can be a switched connection. This connection can comprise a switch, in particular a breaker switch. The connection between the junction point and the second star point/second winding system/opposite end can be a switched connection. This connection can comprise a switch, in particular a breaker switch.

The circuit and in particular the control circuit is adapted to operate the inverters, together with the inductances provided by the winding system, as a DCDC converter device. The DCDC converter device can be provided by multiple (two) DCDC converters. In case of multiple DCDC converters, the control circuit is adapted to operate the DCDC converters in an interleaved was. A first DCDC converter can be provided by the first winding system and the (first) inverter connected thereto and a second DCDC converter can be provided by the second windings system and the (second) inverter connected thereto. The respective winding system provides the operating inductance for the respective inverter. The inverters are provided as switching elements of the DCDCs. The DCDCs are adapted to convert the DC voltages provided at star points of the winding systems and a connector of the battery interface into a voltage provided at the DC ports of the inverters, ie. at the battery interface. The control circuit is adapted to control the inverters to provide a voltage according to a given set point voltage to be provided at the battery interface. The inverters and the winding systems provide one or more DCDCs converting the DC voltage at the charging interface into a (higher) DC voltage at the battery interface.

In some embodiments, the inverters each have the same number of inverter phases. The multiphase AC ports each have a same number of port phases. The number of port phases is preferably identical to the number of inverter phases. The inverters are adapted to operate all or only a subgroup of all port phases. In particular, of a subgroup of inverters or winding systems has a fault, only the residual inverters or winding systems is energized. The control circuit is adapted to provide this function. This allows to run the drive at a lower power in case of a fault instead of deenergizing the complete drive.

### BRIEF DESCRIPTION OF THE DRAWINGS

FIGS. 1-3 show embodiments of the inventive drive circuit including two inverters.

FIGS. 2 and 3 show applications with an electrical machine and with charging interface.

### DETAILED DESCRIPTION OF THE PREFERRED EMBODIMENTS

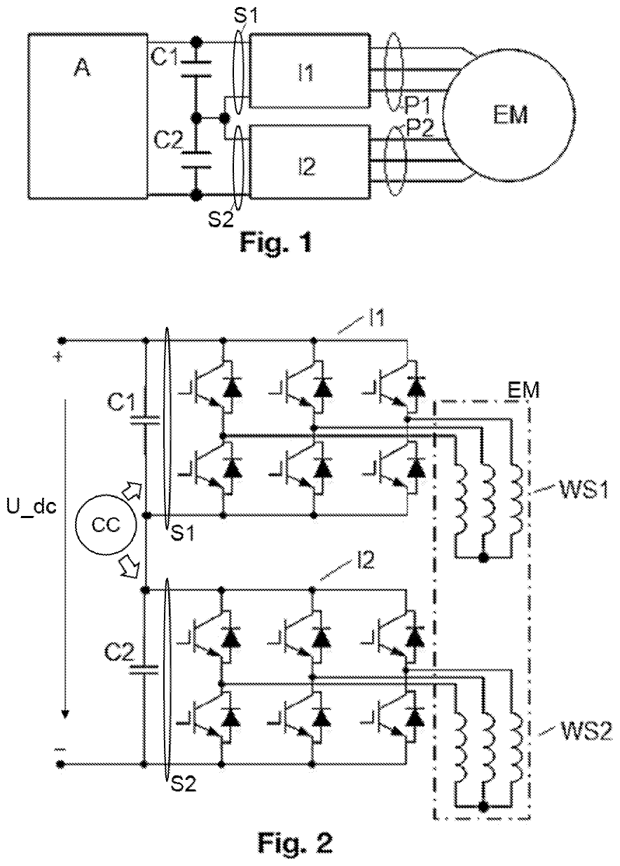

FIG. 1 shows a battery A connected to two inverters I1, I2. The inverters have DC ports S1, S2, which are connected in series. This results in a series connection of the DC ports of the inverters. In case the battery A supplies the inverters I1, I2 with DC power, the DC ports S1, S2 of the inverters I1, I2 are input ports of the inverters. The first DC port S1 of the first inverter I1 is connected in series with the second port S2, which is part of the second inverter I2. On the AC side of the inverters, there are AC ports P1, P2. Each port has three phases such that the parts are multiphase ports. A first capacitor C1 is connected in parallel to the first port S1 of the first inverter I1. A second capacitor C2 is connected in parallel to the second port S2 of the second inverter I2. The capacitors C1, C2 form a series connection. The capacitors C1, C2 are connected via a junction, which is connected to the junction connecting the DC ports S1, S2 of the inverters I1, I2. Thus, also the DC ports S1, S2 of the inverters I1, I2 are connected in a series connection. The series connection of the DC ports S1, S2 and the series connection of the capacitors C1, C2 are connecting in parallel (as regards their respective ends and as regards their respective junction.

In an example, the battery A is 800 V battery. Due to the series connection of the inverter DC ports S1, S2, each inverter is provided with 400 V each at the DC port. The inverters can be provided with switching elements rated lower than 800 V. In particular, the switching elements of the inverters can be MOSFETs or IGBTs, in particular silicon IGBTs. In an example, the switching elements are IGBTs rated 600 V (blocking voltage) or 650 V (blocking voltage). The inverters I1, I2 are three-phase converters (inverters), which are connected in series. A six-phase electric machine EM is connected to the phase ports P1, P2. Each of the phase ports P1, P2 are multiphase ports (each having 3 phases). The phase ports P1, P2 together form a multiphase machine interface of the drive circuit to which an electrical machine with matching winding systems and phases can be connected as given in FIG. 1. In the Figures, the electrical machine EM has a first and a second winding system WS1, WS2, each having 3 phases. The winding systems WS1, WS2 are not connected with each other in a direct way. FIG. 1 shows a drive circuit connected with a battery An external to the drive circuit and connected with an electrical machine EM external to the drive circuit. However, the battery A and/or the electrical machine EM can be part of the drive circuit.

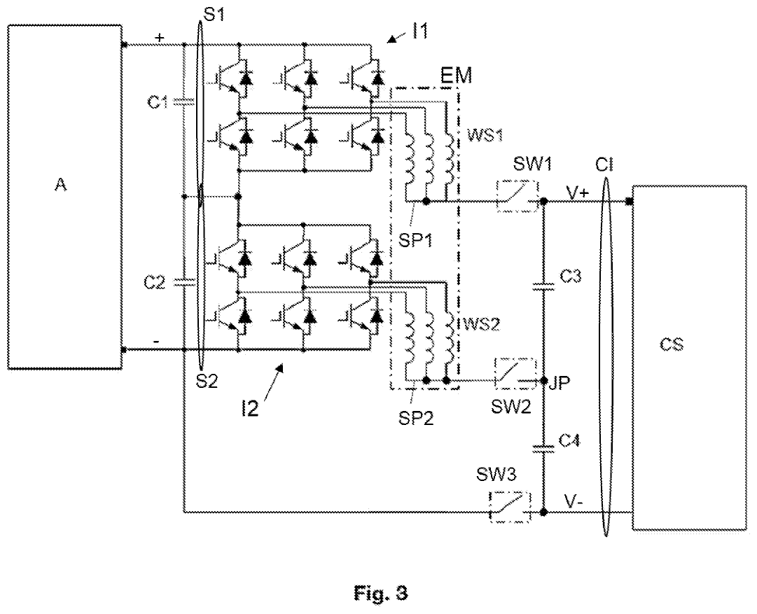

The scheme in FIG. 1 is also given in FIGS. 2 and 3. In FIG. 2, the first inverter I1 and the second inverter I2 are given more in detail and are shown with switching elements (IGBTs). Both inverters I1, I2 are provided as a set of half bridges, in particular one half bridge per phase. For each three phase inverter I1, I2, three half bridges are given. Each half bridge comprises two switching elements connected in series. Further, the capacitors C1 and C2 in FIG. 2 are given in a series connection. Each DC port S1, S2 of each inverter I1, I2, is provided with a parallel capacitor C1, C2. The series connection of the DC ports S1, S2 of the inverters I1, I2 is attached to the battery interface +, −. The battery interface has a positive connector + and a negative connector −, the battery interface being provided as DC connector interface. At the battery interface +, −, the operating voltage U dc is provided. FIG. 2 shows a driving circuit attached to an external electrical machine with winding systems. The circuit of FIG. 2 has a battery interface +, − to which a battery, for example a battery A as given in FIG. 1, can be attached to. A control circuit CC, which is shown only symbolically, is connected to the inverters I1, I2 (and in particular with the switching elements therein).

FIG. 2 can be used for describing the operation of the circuit in traction mode. This mode is provided by the control circuit CC. The control circuit CC controls the inverters I1, I2 according to the traction mode. The traction mode can also be described as drive mode. In this modem, the machine torque of the electrical machine EM is controlled by controlling (via control CC) the phase currents of inverter I1 and I2. Besides, the dc-link capacitance voltages, ie. the voltages provided at the DC ports S1, S2 of the inverters I1, I2 is preferably balanced to make sure that the 800 V is divided essentially equally to them. In this view, “essentially equal” preferably means that the ratio between the lowest voltage at all DC ports and the highest voltage at all DC ports is not greater than 1.1, 1.2, 1.3 or 1.5. This balancing is possible by shifting increasing/decreasing the phase currents of one inverter I1 to the other inverter I2 by correspondingly controlling the inverters via control circuit CC. In case of fault, the drive is able to operate with a reduced number of phases (3, 4, or 5) (in comparison to the total number of phases in the electrical machine/the inverters, which is 6 in the current example). This feature allows for a fail-safe operation, e.g. in autonomous driving or a limp-home feature.

FIG. 2 can be used for describing embodiments with open end windings. In this case, the star point of WS1 would be open. Such a winding system WS1 has first ends connected to inverter I1 as shown in FIG. 2. Further, the ends opposite to the first ends (ie. the open ends resulting from opening the star point) would be connected to inverter I2. Winding system WS2 would not be present. Instead to be connected to WS2 (as depicted in FIG. 2), the AC ports of inverter I2 would be connected to the open ends of WS1 opposite to the AC ports of inverter I1.

FIG. 3 shows the drive circuit for providing another feature, i.e. a charging function. FIG. 3 shows the battery A connected to the two inverters I1, I2 via the respective DC ports S1, S2. The AC ports P1, P2 of the inverters I1, I2 are connected to the winding systems WS1, WS2 of the electrical machine EM. The winding systems WS1, WS2 have star points SP1, SP2. The first winding system WS1 is provided with the first star point SP1. The second winding system WS2 is provided with the second star point SP2. A charging interface CI is given, which is connected to the electrical machine EM, i.e. is connected to one of the winding systems WS1 as well as to a connector − of the battery interface +,−. The charging interface CI has at first connector V+, which is shown as positive connector, as well as a second connector V−, which is shown as a negative connector. The first connector V+ is switchable connected to the start point SP1 of the first winding system WS1. The second connector V− of the charging interface CI is connected to the negative connector − of the battery interface.

Two capacitors C3, C4 are connected in series via a junction point JP. The end of the resulting series connection is connected in parallel to the charging interface CI. The junction point JP of the connection among the capacitors C3, C4 is connected to the star point SP2 of the second winding system WS2. This allows to apply a DC charging voltage at the charging interface CI. The inverters I1, I2 are operated in order to provide a DC/DC converter. The DC/DC converter provided by the inverters converts the voltage at the charging interface CI into a desired DC voltage at the battery interface +, − in order to charge the battery A using a DC charging current. In this way, charging station CS can be attached to the charging interface ci and can be used for charging the battery A. In order to provide the DC/DC converter, the inverters are used as switching element of the inverter and the inductivities of the windings are used as operating inductor of the and DC/DC converter.

A switchable connection is given between the first (positive) connector V+ of the charging interface CI and the first star point SP1 of the first winding system WS. The switchable connection is provided by the first switch SW1. A second switch SW2 is provided between the junction point JP and the star point SP2 of the second winding system WS2. A third switch SW3 is provided between the second (negative) connector V− of the charging interface CI and the second (negative) connector − of the battery interface.

In the following, an application of the circuit shown in FIG. 3 is described. In order to charge a 800 V battery A from a 400 V charging station CS, the circuit in FIG. 3 is used. Here, the charging station CS is connected to the two star points SP1, SP2 via two input capacitances C3, C4 and to the negative connector − of the battery A. In this case, the inductances provided by the windings of the electrical machine EM and the inverters I1, I2 are used as interleaved DCDC (boost) converter. The control circuit can be adapted to switch the switches of the first inverter and the switches of the second inverter in an interleaved manner. The input capacitances C3, C4 are used to filter out the voltage and current ripples. Each inverter I1, I2 with the 3-phase winding system connected thereto are used to boost (convert) the voltage from 200 V on charging station side (ie. between SP1 and SP2 as well as between SP2 and V−) to 400 V on dc-link side, i.e. at each of the capacitors C1, C2. The input voltage (of 400 V) at the charging interface is split in fractions (halfs) thereof. Each of the splitted voltages are DCDC-converted to a voltage at the DC ports of the inverters. Since the ports are connected, the voltage at the battery interface is the sum of the voltages provided at the DC ports S1, S2. This results in boosting the voltage from 400 V to 800 V. The charging scenario is enabled by connecting the three switches SW1, SW2, and SW3. In case of traction, these switches SW1-SW3 are switched off in order not to disturb the EM operation. The control circuit is adapted to control the switches SW1-SW3 according to the current scenario (charging or driving/traction).

1. An electric vehicle drive circuit comprising:
a first inverter with a first DC port; and
a second inverter with a second DC port, the first DC port and the second DC port being connected in a series connection,
wherein the series connection of the first DC port and the second DC port is connected to a battery interface, the first and the second inverters each having a multiphase AC port, and
wherein the multiphase AC ports of the first and the second inverters form a multiphase machine interface.

2. The electric vehicle drive circuit according to claim 1 further comprising a control circuit connected to control inputs of both, the first and the second inverters, the control circuit being adapted to control the first and the second inverters in order to jointly provide a rotary current system at the multiphase machine interface.

3. The electric vehicle drive circuit according to claim 2, wherein the control circuit is adapted to limit the voltages occurring at the DC ports to a voltage limit not greater than the sum of a given voltage tolerance gap and the half of the voltage occurring at the battery interface.

4. The electric vehicle drive circuit according to claim 1, wherein each of the inverters has a rating voltage lower than the operating voltage of the battery interface.

5. The electric vehicle drive circuit according to claim 1, wherein a first capacitor is connected in parallel to the first DC port and a second capacitor is connected in parallel to the second DC port.

6. The electric vehicle drive circuit according to claim 1, further comprising an electrical machine having a first and a second winding system, both winding systems operating the same rotor of the electrical machine, both inverters being adapted to jointly provide a single, rotary current system at the multiphase machine interface.

7. The electric vehicle drive circuit according to claim 6, further comprising a DC charging interface being connected to a star point of a first of the winding systems and to a connector of the battery interface.

8. The electric vehicle drive circuit according to claim 7, wherein the DC charging interface comprises two voltage connectors, wherein a capacitive series connection is connected to the two voltage connectors, the capacitive series connection having a junction point connected to a star point of a second of the winding systems.

9. The electric vehicle drive circuit according to claim 6, wherein the circuit is adapted to operate the inverters, together with the inductances provided by the winding system, as at least one DCDC converter converting the DC voltages at star points of the winding systems and between one of these star points and a connector of the battery interface into voltages provided at the DC ports of the inverters.

10. The electric vehicle drive circuit according to claim 1, wherein the inverters each have a same number of inverter phases and wherein the multiphase AC ports each have a same number of port phases identical to the inverter phases, the inverters being adapted to operate all or only a subgroup of all the port phases.
